(19) United States
(12) Patent Application Publication
(10) Pub. No.: US 2002/0074068 A1
(43) Pub. Date: Jun. 20, 2002

(54) Tire anti-puncture product

(76) Inventors: Charles A. Howland, Temple, NH (US); Eric Lemaire, Bromont (CA); Michael E. Fordham, Jaffrey, NH (US)

Correspondence Address: MAINE & ASMUS, 100 MAIN STREET, P O BOX 3445, NASHUA, NH, 03061-3445, US

(21) Appl. No.: 09/943,750

(22) Filed: Aug. 30, 2001

Related U.S. Application Data
(60) Provisional application No. 60/229,708, filed on Aug. 31, 2000.
(60) Provisional application No. 60/229,242, filed on Aug. 30, 2000.

(51) Int. Cl. B60C 7/00; D02G 3/48

(52) U.S. Cl. 152/310; 152/527; 152/529

(57) ABSTRACT

The invention is directed to fabric-based inserts and layers for use with tires in order to provide an improved level of puncture resistance to the tire. Disclosed embodiments of the invention include tire anti-puncture layers including puncture-resistant layers that comprise a single or multiple layers of fabric. Preferably, for low cost and low abrasion, the puncture-resistant layers comprise fibers having a tensile strength or tenacity of less than about 15 g/denier. In some preferred constructions, especially where the puncture-resistant layer comprises a single layer of fabric, the puncture-resistant layer comprises a high cover factor, tightly woven fabric, for example having a round packed cover factor of at least about 40% of full in the warp direction and at least about 65% of full in the fill direction. In other embodiments, especially where the puncture-resistant layer comprises multiple layers of fabric, lower cover, less tightly woven woven fabrics can be used, or, alternatively, non-woven fabrics such as knitted or felted fabrics (felts) can be used. Some such preferred, less tightly-woven fabrics are woven from untwisted yarns, enabling the fibers or filaments comprising the yarns to spread out into a tape-like configuration under compression, thereby increasing the effective cover factor and level of puncture resistance over that predicted from the round packed cover factor. A “taped fiber density” calculation is presented for predicting the effective cover factor of such taped-out woven fabrics, and certain preferred embodiments of such fabrics have a taped fiber density of at least about 80% of full in at least one of the warp and fill directions. In some embodiments, the puncture-resistant layer, or one or more layers of fabric comprising the layer, are coated with polymeric coatings to increase the level of puncture resistance. In some embodiments, the tire anti-puncture device is configured as a separable strip that can be placed within a tire to act as a liner. In other embodiments, the puncture-resistant device is incorporated within the cross-section of the tire body itself. While the tire anti-puncture device in some embodiments comprises just the puncture-resistant layer, in other embodiments, one or more low abrasion layers can be added to isolate and protect the tire and/or inner tube, if present, from the puncture-resistant layer. Such law abrasion layer(s) are particularly useful for embodiments involving puncture-resistant layers coated with polymeric coatings containing abrasive fillers, which can serve to increase puncture resistance but tent also to increase abrasiveness of the puncture-resistant layer.

### RELATED APPLICATIONS

This application claims priority under 35 U.S.C. §119(e) to U.S. Provisional Application serial No. 60/229,708 entitled TIRE ANTI-PUNCTURE PRODUCT, filed Aug, 31, 2000 and to U.S. Provisional Application serial No. 60/229,242 having the same title, filed Aug. 30, 2000, both incorporated herein by reference.

### FIELD OF INVENTION

The present invention is directed to fabric-based devices for use in tires as puncture-resistant layers.

### BACKGROUND OF THE INVENTION

A variety of techniques and materials are known in the prior art for providing puncture resistance to tires. For example, it is known to use sealants in order to plug holes in the tire. Such sealants are typically fluids able to fill the puncture and subsequently harden to form a seal.

Puncture-resistant layers or liners have also been utilized to provide puncture resistance to tires. For example, extruded or molded strips made of various resins, but containing no fibers therein, have been utilized as puncture-resistant layers. In addition, para-aramid felt strips made of felted fiber having a strength or tenacity of greater than 15 g/denier (gpd) have also been utilized. Other examples of puncture-resistant materials utilized in the prior art for providing puncture resistance to tires include Vectran™ liquid crystal polyester and/or para-aramid coated fabrics made of fibers having a strength or tenacity of greater than 15 g/denier (gpd).

The extruded or molded strips utilized in the prior art tend to have relatively poor puncture resistance, while the materials formed of high tenacity fibers (i.e., having a tenacity greater than 15 gpd), while providing good puncture resistance, tend to be expensive and can cause an undesirable level of abrasion, which can damage the tire cores and/or inner tubes of the tire in which they are installed. Accordingly, there is a need in the art for puncture-resistant materials and layers for use in tires having a desirable combination of good puncture resistance, relatively low cost, and a relatively low degree of abrasion, so as to prevent damage to the tire and/or inner tube in use.

### SUMMARY OF THE INVENTION

The invention is directed to fabric-based inserts and layers for use with tires in order to provide an improved level of puncture resistance to the tire. Disclosed embodiments of the invention include tire anti-puncture layers including puncture-resistant layers that comprise a single or multiple layers of fabric. Preferably, for low cost and low abrasion, the puncture-resistant layers comprise fibers having a tensile strength or tenacity of less than about 15 g/denier. In some preferred constructions, especially where the puncture-resistant layer comprises a single layer of fabric, the puncture-resistant layer comprises a high cover factor, tightly woven fabric, for example having a round packed cover factor of at least about 40% of full in the warp direction and at least about 65% of full in the fill direction. In other embodiments, especially where the puncture-resistant layer comprises multiple layers of fabric, lower cover, less tightly woven woven fabrics can be used, or, alternatively, non-woven fabrics such as knitted or felted fabrics (felts) can be used. Some such preferred, less tightly-woven fabrics are woven from untwisted yarns, enabling the fibers or filaments comprising the yarns to spread out into a tape-like configuration under compression, thereby increasing the effective cover factor and level of puncture resistance over that predicted from the round packed cover factor. A “taped fiber density” calculation is presented for predicting the effective cover factor of such taped-out woven fabrics, and certain preferred embodiments of such fabrics have a taped fiber density of at least about 80% of full in at least one of the warp and fill directions. In some embodiments, the puncture-resistant layer, or one or more layers of fabric comprising the layer, are coated with polymeric coatings to increase the level of puncture resistance. In some embodiments, the tire anti-puncture device is configured as a separable strip that can be placed within a tire to act as a liner. In other embodiments, the puncture-resistant device is incorporated within the cross-section of the tire body itself. While the tire anti-puncture device in some embodiments comprises just the puncture-resistant layer, in other embodiments, one or more low abrasion layers can be added to isolate and protect the tire and/or inner tube, if present, from the puncture-resistant layer. Such law abrasion layer(s) are particularly useful for embodiments involving puncture-resistant layers coated with polymeric coatings containing abrasive fillers, which can serve to increase puncture resistance but tent also to increase abrasiveness of the puncture-resistant layer.

In one aspect, a tire anti-puncture device comprising a puncture resistant layer comprising at least two layers of woven fabric material, each layer having a taped fiber density of at least about 80% of full cover in at least one of the warp and fill and comprising filaments having a tenacity of less than about 15 g/denier, wherein the puncture-resistant layer is shaped and configured to form a belt within and around the periphery a tire is disclosed.

In another embodiment, a tire anti-puncture device comprising a puncture resistant layer comprising a woven fabric having a round packed cover factor of at least about 40% of full cover in the warp and at least about 65% of full cover in the fill, the fabric comprising fibers having a tenacity of less than about 15 g/denier, wherein the puncture-resistant layer is shaped and configured to form a belt within and around the periphery a tire is disclosed.

In another embodiment, a tire anti-puncture device comprising a puncture resistant layer comprising at least two layers of fabric, each fabric layer comprising fibers having a tenacity of less than about 15 g/denier and each layer having a bulk density, excluding any coatings applied to the fabric layer, that is at least about 20% of the density of any polymeric material forming the fibers of the fabric layers, wherein the puncture-resistant layer is shaped and configured to form a belt within and around the periphery a tire is disclosed.

In another embodiment, a tire anti-puncture device comprising a puncture resistant layer comprising a single fabric layer, the fabric layer comprising fibers having a tenacity of less than about 15 g/denier and the fabric layer having a bulk density, excluding any coatings applied to the fabric layer, that is at least about 30% of the density of any polymeric material forming the fibers of the fabric layer, wherein the puncture-resistant layer is shaped and configured to form a belt within and around the periphery a tire is disclosed.

In another embodiment, a tire anti-puncture device comprising a puncture resistant layer comprising at least one fabric layer comprising fibers having a tenacity of less than about 15 g/denier; and at least one covering layer having an abrasion limit of less than about 2000 cycles as measured by a Tabor test utilizing a CS10 wheel with 1000 gram load, wherein the test is run to tensile failure defined as a reduction of the tensile strength of the fabric of at least about 25%, and wherein the puncture-resistant layer is shaped and configured to form a belt within and around the periphery a tire is disclosed.

In another embodiment, a tire anti-puncture device comprising a puncture resistant layer comprising a fabric comprising fibers having a tenacity of less than about 15 g/denier, the puncture resistant layer further having a puncture resistance of greater than about 2.0 lbs. force, wherein the puncture resistance is defined as the level force required to force a 0.05 in. diameter polished steel commercial hand sewing needle through the puncture resistant layer, when clamped and supported in a 1 in. diameter ring, such that the point of the needle projects from the side of the fabric opposite that to which the force is applied by a distance of about 0.045 inch and wherein the puncture-resistant layer is shaped and configured to form a belt within and around the periphery a tire is disclosed.

In another embodiment, an tire anti-puncture device having a puncture resistant layer comprising at least one fabric layer comprising fibers having a tenacity of less than about 15 g/denier; and a coating applied to the fabric layer, the coating comprising a polymeric material that penetrates into and occupies at least a portion of the void space between fibers forming the fabric, wherein the puncture-resistant layer is shaped and configured to form a belt within and around the periphery a tire is disclosed.

In another embodiment, a tire anti-puncture device having a puncture resistant layer comprising at least fabric layer comprising fibers having a tenacity of less than about 15 g/denier; and a coating applied as a liquid to the fabric layer, the applied coating, upon hardening, comprising a polymeric material having a bulk modulus not exceeding about 10,000 psi, wherein the puncture-resistant layer is shaped and configured to form a belt within and around the periphery a tire is disclosed.

In another embodiment, a tire anti-puncture device having a puncture resistant layer comprising at least one fabric layer comprising fibers having a tenacity of less than about 15 g/denier; and a coating applied as a liquid to the fabric layer, the applied coating, upon hardening comprising a polymeric material having dispersed therein an abrasive particulate material, wherein the puncture-resistant layer is shaped and configured to form a belt within and around the periphery a tire is disclosed.

Other advantages, novel features, and objects of the invention will become apparent from the following detailed description of the invention when considered in conjunction with the accompanying drawings, which are schematic and which are not intended to be drawn to scale. In the figures, each identical or nearly identical component that is illustrated in various figures is represented by a single numeral. For purposes of clarity, not every component is labeled in every figure, nor is every component of each embodiment of the invention shown where illustration is not necessary to allow those of ordinary skill in the art to understand the invention.

### BRIEF DESCRIPTION OF THE DRAWINGS

FIG. 1 is a schematic, cross-sectional view of a tire including an anti-puncture device configured as a liner within the tire, according to one embodiment of the invention;

FIG. 2 is a schematic, perspective view of a portion of the anti-puncture device of FIG. 1, illustrating the details of the layers in cross-section; and

FIG. 3 is a schematic, cross-sectional illustration of a tire including therewithin a second embodiment of an anti-puncture device according to the invention.

### DETAILED DESCRIPTION

The present invention provides a variety of tire anti-puncture devices for preventing puncture damage to tires and deflation of tires caused by punctures. The tire anti-puncture devices provided according to the invention can be configured as one or more layers formed of woven and/or non-woven fabrics having at least one puncture-resistant layer, which can similarly be formed from a single or multiple layers of woven and/or non-woven fabric, having a puncture resistance of at least about 2 lbs. force, and preferably at least about 3 lbs. force when measured with the penetration test method described in more detail below.

The tire anti-puncture devices are preferably shaped and configured to form a belt within and around the periphery of a tire in which they are installed. “Shaped and configured to form a belt within and around the periphery of a tire,” as used herein, refers to the devices having a predetermined shape and size selected to allow the device to be installed within a tire (either within the interior space of the tire body adjacent to the inner, tube- or rim-facing surface of the tire body or within the cross-section of the tire body itself, as described in more detail below) such that the device, when installed, forms a substantially continuous annular layer within a tire, such that the annular layer is in contact with, is formed within, is adjacent to, or is essentially continuously co-planar to at least a portion of the tire body making ground contact, when the tire is installed in an operable configuration on a vehicle. As such, the tire anti-puncture device itself can comprise, in preferred embodiments a continuous band/layer, which is installed as a single unit to form the substantially continuous annular layer within the tire, or, alternatively, the device can comprise a plurality of smaller discontinuous belts or patches, which can be installed, and preferably at least partially overlapped upon each other, within the tire and around the periphery to form the substantially continuous annular layer within the tire.

As described in more detail below, a variety of different configurations and fabric types can potentially be utilized within the scope of the invention for providing the above-mentioned penetration resistance. Described below are various configurations for providing penetration-resistant layers according to the invention able to provide a desired level of penetration resistance. Those of ordinary skill in the art, based on the disclosure below and standard penetration testing methods described in more detail below, can readily, and without undue experimentation, select materials, treatments, and parameters based on the teachings provided herein to construct other penetration-resistant devices not necessarily specifically exemplified or disclosed capable of providing the desired level of penetration resistance. Each of such variations falling within the scope of the appended claims forming part of the present invention.

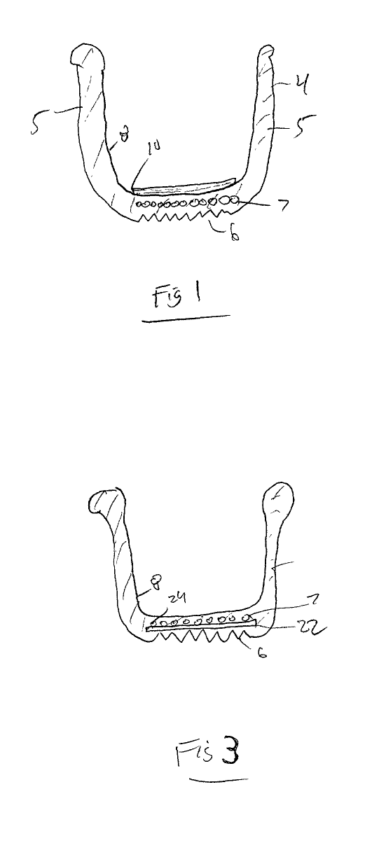

The anti-puncture devices disclosed herein can be provided in a variety of forms. For example, FIG. 1 shows a first embodiment of an anti-puncture device provided according to the invention, wherein the anti-puncture device comprises a tire liner in the form of a separable strip shaped and configured to be either removably insertable within a tire or bondable to an inner surface of the tire, the strip including a single or multiple puncture resistant layers. FIG. 1 illustrates a cross section of a tire 4, for example a bicycle tire, having sidewalls 5, a tread region 6, a cord layer 7, and an inner surface 8 facing an inner tube, if present (not shown) (or facing a rim for tubeless tires, such as those most commonly used in wheeled motor vehicles). Anti-puncture strip 10 comprises a liner that is separable from and in physical contact with inner surface 8 of tire 4.

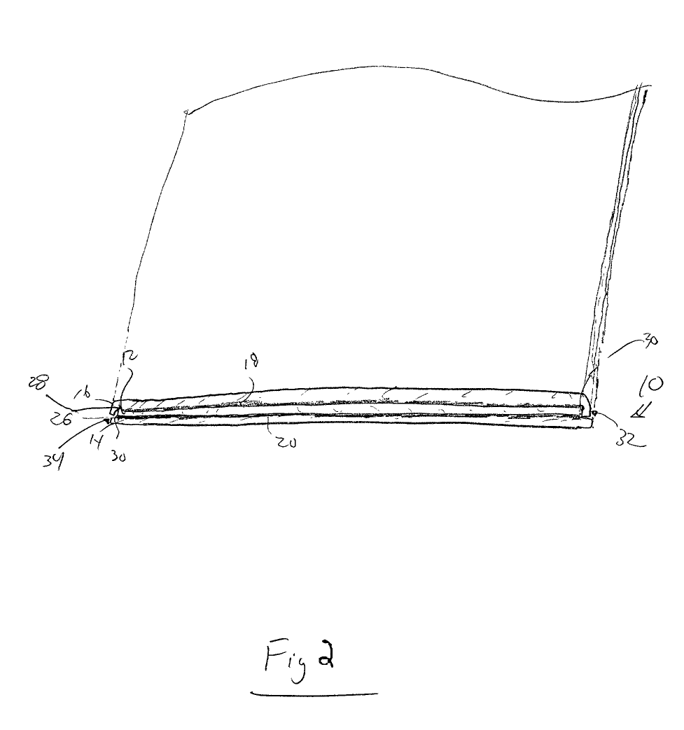

Anti-puncture liner 10 is shown in greater detail in FIG. 2. In the embodiment illustrated in FIG. 3, anti-puncture liner 10 comprises a plurality of layers including a puncture-resistant layer 12 interposed between two low-abrasion layers 14 and 16. The puncture-resistant layer 12 can be bonded to the low-abrasion layers 14 and 16 via bonding layers 18 and 20. As described in much more detail below, puncture-resistant layer 12 can be formed of a single layer of puncture-resistant fabric or, in alternative embodiments, can be formed of a plurality of individual layers of fabric layered upon, and optionally bonded to each other, for example in a similar fashion as described below with regard to bonding of the puncture-resistant layer to the covering layer(s), to together form puncture-resistant layer 12. The particular materials, construction, and fabrication of the illustrated layers of anti-puncture device 10 are described in more detail below. In alternative embodiments, anti-puncture device 10 may have only a puncture-resistant layer 12 and a single low-abrasion layer (for example either layer 14 or layer 16) for applications where preventing abrasion with the inner surface of the tire and/or an inner tube within the tire is not critical. For embodiments where the anti-puncture device includes only one covering layer and is used as a tire liner in a tire containing an inner tube, it is preferred to orient the liner so that the low abrasion covering layer is positioned adjacent to the inner tube.

In yet other embodiments, low-abrasion covering layers 14 and 16 can be eliminated and penetration-resistant layer 12 may be used alone to provide penetration resistance. In addition, in alternative embodiments, instead of bonding low-abrasion covering layers 14 and 16 to penetration-resistant layer 12 via bonding layers 18 and 20, the layers may simply be physically stacked one upon the other without intermediate bonding, or, alternatively, bonding may be effected by a mechanical process, such as needling. Similarly, such mechanical inter-bonding techniques can also be used to bond together the layers of the puncture-resistant layer, for embodiments including a multi-layer puncture resistant layer.

FIG. 3 shows an alternative embodiment for providing an anti-puncture layer for preventing tire puncture. In the embodiment illustrated in FIG. 2, anti-puncture device 22 is not formed as a liner or strip placed within the tire, as illustrated in the embodiment in FIG. 1, but rather is provided within the cross section of the tire body itself. In the illustrated embodiment, anti-puncture layer 22 has been installed within the cross-section of the tire body so that it is positioned on the tread side of cord layer 7. In such embodiments, because anti -puncture device 22 does not contact inner surface 8 of the tire or any inner tubes within the tire, provision of low-abrasion covering layers, e.g., layers 14 and 16, is generally not necessary and the anti-puncture device 22 can be comprised simply of a puncture-resistant layer, for example similar or equivalent to layer 12 shown in FIG. 3. In yet another alternative embodiment (not shown), anti-puncture device 22 is bonded to inner surface 8 or formed within the cross section of the tire on the tube or rim facing side 24 of cord layer 7.

Referring now to the construction of puncture-resistant layer 12, a wide variety of fiber types can potentially be used within the scope of the invention comprising a variety of natural and/or synthetic materials, most typically polymeric materials. For cost considerations, preferred embodiments of the invention utilize fibers and yarns that are not formed of pure “high performance” fibers, such as KEVLAR™ para-aramid and VECTRAN™ liquid crystal polyesters, having a fiber strength/tenacity of greater than about 15 g/denier. Most preferred, within the context of the invention, are yarns and fabrics containing fibers having a strength/tenacity of between about 3 and about 8 g/denier, which fibers are much less expensive than the above-mentioned high performance fibers, while providing adequate tensile strength to resist penetration when constructed, configured, and treated as described herein below. In one preferred embodiment, polyamide (nylon) fibers are used for forming puncture-resistant fabric layer 12. In another preferred embodiment, puncture-resistant fabric layer 12 is formed of one of the commercially available types of polyesters having a fiber tenacity of between about 3 and about 8 g/denier.

The required level of penetration resistance of puncture-resistant layer 12 is based on the threat that needs to be stopped by the layer to prevent damage to the tire and/or inner tube. The harder and sharper the threat the higher the level of puncture resistance must be. Sharp thorns and other typical naturally occurring threats typically require at least about 2 lbs. force of penetration resistance from the puncture-resistant layer, as measured by the penetration test described below. The 2 lbs. force value has been found, within the scope of the invention, to be adequate to prevent penetration by typically encountered natural objects. Thorns and the like tend to buckle above this load and are in this way prevented from completing penetration by the puncture-resistant layer.

The above-referred to penetration resistance value is measured according to the test described immediately below. Penetration load is measured with a compression testing machine, for example an Instron™ type machine, utilizing a 0.05 inch diameter polished steel commercial hand sewing needle as a test probe. The test is performed with the penetration-resistant fabric layer clamped in a 1 in diameter ring, and a microscope is used in order to observe the depth of penetration of the test probe through the fabric. The penetration resistance is determined as penetration load required to force the test probe through the back of the tested material such that the probe tip extends from the back side of the material by a distance of 0.045 inch.

In general, and as described in more detail below, this minimum desirable penetration resistance of the pressure-resistant layer can be achieved in, for example, three ways: 1) by use of a single layer of fabric having a high fiber density or cover factor, for example a tightly woven high cover fabric optionally combined with shrinkage and/or callendering of the fabric and optionally including a coating comprised of a polymeric material having a relatively low bulk modulus (i.e., a soft coating, described in more detail below); 2) forming puncture-resistant layer 12 from a plurality of layers of a fabric having a lower fiber density/cover factor, for example having a lower cover factor and being less tightly woven, optionally including a soft-coating as mentioned above; and 3) utilizing a single layer of a lighter fabric as in (2) above, but combining the layer with a coating comprised of a material having a higher bulk modulus (i.e., a “hard coating”, as described in more detail below).

Option 1 described above generally can result in the lightest, least costly design of the three options, and also can have the best level of flexibility and fatigue resistance. The multi-layer approach described above in (2) can also provide a high level of puncture resistance and good flexibility characteristics, especially when the lamination of the multiple layers is accomplished by using a very light and flexible bonding agent, which agents are well known in the fabric bonding arts, or, alternatively, by an intermediate mechanical tacking method, such methods being also well known. Such multi-layer composites for forming puncture-resistant layer 12 tend, however, to be somewhat more expensive to fabricate than the single layer fabrics described in (1) above. The third approach mentioned above of using a lower cover, more open fabric in a single layer typically requires a coating treatment with a harder, higher modulus material, such as an epoxy material as disclosed in commonly-owned U.S. Pat. No. 5,565,264, incorporated herein by reference. Such high modulus coatings, typically formed of a polymeric material having a bulk modulus exceeding 10,000 psi, tend to reduce the degree of flexibility and fatigue resistance of the puncture-resistant layer. However, heavier coats (i.e., applying a greater weight of coating material per square yard of fabric) of a soft, lower modulus coating material can alternatively be substituted for the harder coatings to achieve the desired level of puncture resistance.

Fabric Construction for the Puncture-Resistant Layer

The term “fiber” as used herein refers to an elongate, individual and essentially monolithic unit of matter, either natural or synthetic, that forms the basic element of a fabric. The term “filament” as used herein refers to a fiber of an indefinite or extreme length. The term “staple fiber” as used herein refers to fibers having a shorter length (less than about 40 inches and typically between about 1 inch and about 4 inches), such fibers either normally having such a length (e.g. many natural fibers) or being cut or stretch broken from filaments. A “fiber bundle” as used herein refers to a plurality of fibers and/or filaments grouped together to form a multi fiber strand bundle. A “yarn” as used herein refers to any continuous strand of fibers or filaments in a form suitable for knitting, weaving, or otherwise intertwining to form a textile fabric including, but not limited to: a number of fibers twisted together into a single fiber bundle (spun yarn); a number of filaments laid together without twist (a zero-twist yarn); a number of filaments laid together with a degree of twist; a single filament with or without twist 9a monofilament yarn); and two or more fiber bundles twisted together (a plied yarn). A “woven fabric” as used herein refers to a fabric characterized by intersecting warp and fill yarns interlaced so that they cross each other at essentially right angles, the term including, but not limited to well known woven structures such as plain weave (including variations thereof such as basket weaves), twill weave, and satin weave.

In one particularly preferred embodiment, puncture-resistant layer 12 is formed of one or more layers of a tightly woven fabric. A “tightly woven,” “high cover factor,” or “high cover” woven fabric as used herein refers to a woven fabric having a round packed cover factor of greater than about 40% of full cover in the warp and greater than about 65% of full cover in the fill. “Round packed cover factor” or “cover factor” as used herein refers to the fraction, expressed as a percentage, of the total area of a fabric occupied by bundles of fibers (either staple fibers for spun yarns or continuous filament fibers) (hereinafter referred to as “fiber bundles”) forming the warp and fill yarns of woven fabric, assuming that the yarns have a circular cross-sectional shape, which assumption is generally good for fabrics formed of twisted yarns of relative high denier (e.g. greater than about 100 denier). Yarns of the woven fabrics of the invention can comprise either a single fiber bundle, or, alternatively, two or more fiber bundles intertwined together to form a plied yarn. The above-mentioned cover factor is expressed as a percent of full coverage (i.e. 100% of the total area occupied by rounded yarns such as would occur if the rounded yarns were laid out in a single layer, side by side, and in contact with each other).

“Round packed cover factor” or “cover factor” as used herein can be calculated, for a unit length of fabric, as the sum of each of the widths of the yarns (assuming a round cross-sectional shape, see sentence below for description of appropriate yarn width for warp and fill) in a given cross-section, divided by the total width of the fabric cross-section (see also U.S. Pat. No. 5,565,264). When calculating the round packed fiber density in the warp, the appropriate yarn width utilized is simply the width of each warp yarn; however, when calculating the cover factor in the fill by this method, for constructions where there is a warp yarn positioned between each of the fill yarns due to the crimp in the woven structure, a more appropriate effective yarn width which is used in the calculation is equal to the sum of the width of a fill yarn and a warp yarn. For more complex woven constructions, the above calculations can readily be modified to determine cover factors and/or the cover factor can be determined by measuring fractional area of coverage via microscopic observation of the fabric, image analysis, etc., as would be apparent to those skilled in the art.

The cover factor of the fiber bundles/yarns in the machine direction and the cross machine direction have a large impact, for woven fabrics, on the puncture resistance of the fabric. Fabrics of low cover (i.e., fabrics having a round packed fiber density of less than about 40% of full in the warp and less than about 65% of full in the fill will generally not yield a desirable level of puncture resistance without utilizing high modulus, hard coating materials, when the fabrics are utilized as a single layer for forming puncture resistant layer 12. As previously stated, such hard coatings are generally less preferred because they can tend to reduce flexibility and fatigue life of the fabric.

It is also desirable to construct anti-puncture device 10 such that each of the layers comprising the device is as thin as possible, within the constraints of achieving the desired puncture resistance, and such that the total mass of the system is minimized. In order to control the total mass of a puncture-resistant layer in an anti-puncture device utilizing a single puncture-resistant layer, woven fabrics formed of yarns ranging between about 100 denier and about 500 denier are generally preferred. In alternative embodiments, non-woven fabrics, for example knitted fabrics or felting (felts), can be utilized in place of the woven fabric for comprising the single puncture-resistant layer. In such embodiments, a fabric mass of between about 3-15 oz/sq. yd. is generally preferred in order to provide a similar degree of penetration resistance and bulk fabric density, defined below, as the previously described preferred woven fabrics, utilizing yarns having a weight per unit length of between about 100-500 denier.

For embodiments of puncture-resistant layer 12 formed of multiple fabric layers, it is possible to utilize, for at least one layer, preferably more than one layer, and more preferably each layer, a less tightly woven, lower cover fabric (i.e. having a round pack cover factor less than about 40% of full in the warp and less than about 65% of full in the fill, and/or having a taped fiber density of less than about 80% of full in each of the warp and fill). In such multiple layer designs, smaller yarns, for example having a weight per unit length of between about 20-100 denier, can also be used. Alternatively, as a substitute to the directly above-mentioned woven fabrics, non-woven fabric layers, such as knitted layers and/or felt layers, having a fabric weight per unit area of between about 0.5 to 3 oz/sq. yd can be utilized to provide a similar overall fiber content (i.e. bulk fabric density) and penetration resistance in multi-layer designs. In general, it can be more difficult to achieve high cover factors and high fiber densities with single layers of the lighter weight fabrics described immediately above for use in the multi-layer systems, thus, a desirable level of puncture resistance is typically achieved with such fabrics through the use of stacking and/or laminating multiple layers of such fabrics. The number of layers required for a particular fabric construction can be readily determined by those of ordinary skill in the art via routine puncture testing, as described above.

In embodiments for forming puncture-resistant layer 12 from multiple layers fabrics formed of lighter weight yarns (e.g. less than 100 denier), and/or lower cover/fiber density fabrics, and especially for embodiments where the yarns forming the fabrics are untwisted, the fibers or filaments forming the yarns tend to become oriented with respect to each other such that the fabric has a flattened, tape-like (“taped-out”) shape. In other words, for these types of fabrics, the fibers or filaments forming the yarns tend to, in response to an applied force, spread out cover more area than would be predicted based on the round packed cover factor calculation given above. The tendency of such fabrics to form a taped-out configuration can be enhanced by, for example, callendering the fabric or utilizing other known methods for compressing and densifying fabrics, as would be apparent to those of ordinary skill in the art.

Such taped out fabrics can have an effective cover level and overall bulk density and associated puncture resistance, significantly higher than the same fabric had before forming the taped out configuration. Upon forming the taped out configuration, a more representative effective cover level and fiber density is calculated based on the individual fibers or filaments and the individual fiber/filament diameters, as opposed to that based on yarns and yarn diameters as described above in the context of the round packed cover factor. In the most preferred embodiments, according to the invention, such taped out fabrics have a taped fiber density of at least about 80% of full cover in at least one of the warp and fill, more preferably of at least about 85% of full, and in other preferred embodiments of at least about 95% of full. The “taped fiber density”, is analogous the earlier defined round packed cover factor, except that it is based on the number and diameter of the individual fibers or filaments forming the yarns. Accordingly, the “taped fiber density” represents the fraction of the total area of a fabric occupied by the individual fibers/filaments, assuming that the fibers/filaments are all lying flat, side by side, and in a single layer. Thus, for a fabric with a known number of yarns per inch of fabric (in the warp or fill), a known number of fibers or filaments contained in a given cross-section of yarn, and a known diameter per fiber/filament (each of these quantities is typically known or readily calculated from known parameters by those of ordinary skill in the art), the “taped fiber density”, in either the warp or fill, is calculated by multiplying the number of yarns in the cross-section (i.e. yarns per inch multiplied by the width of the fabric cross-section) by the number of fibers or filaments contained in a given cross-section of yarn to obtain the total number of fibers/filaments, multiplying the total number of fibers/filaments so calculated by the diameter of each fiber/filament, and finally dividing this by the total width of the fabric cross-section. This result can then be expressed as a percentage of full cover by multiplying it by 100%.

The tightness of the weave and the fiber packing density can be increased, in some preferred embodiments, by shrinking the fabric after fabrication of the puncture resistant griege fabric and before construction of the anti-puncture device. Shrinkage is effective at densifying fabrics to improve their puncture resistance, and can be performed by a variety of standard techniques well-known to those of ordinary skill in the art, for example including, but not limited to, callendering with heated rollers, conveying the fabric on a tenter frame through a heated oven, etc. Depending on the particular configuration of the fabric and the identity of the material from which the base fiber is constructed, shrinkage can increase the density of the fabrics, either fiber density or bulk density, by between about 1-10% (e.g. for woven fabrics, shrinkage can increase the round packed cover factor or the taped fiber density by between about 1-10%). Shrinkage can be especially effective for densifying fabrics constructed of high shrinkage tension yarns, for example those formed from polyester or nylon fibers.

As described in more detail below, it is preferred in certain embodiments, in order to increase puncture resistance, to coat the fabric layer(s) forming puncture resistant layer 12 with a polymeric, fabric-densifying coating. In general, the overall bulk density (or “bulk fabric density”) of the puncture-resistant layer, both with and without the above-mentioned coating, provides a good indication of the packing density of the fibers or filaments forming the layer and the degree of saturation of the polymeric coating into the fabric's fiber bundles. In general, the maximum, uncoated bulk density of the fabric is limited by the density of the base polymer material forming the base fiber. For example, for embodiments using polyester fiber-based fabrics for forming the puncture resistant layer, the maximum, uncoated bulk density of the fabric is limited by the density of the polyester polymer forming the base fiber, which is about 1.38 grams per cubic centimeter. Since all fabrics have some voids in their structure, the actual bulk density of the fabric formed from such a base fiber will always be lower than the above density for the base fiber polymer. How close the overall bulk fabric density is to the theoretical maximum density (i.e. the density of the polymer forming the base fiber) is directly correlated to the cover factor and tightness of the weave of the fabric as well, in general, to its level of puncture resistance. Denser fabric structures typically have better puncture resistance and allow for the use of a thinner puncture-resistant fabric layer in obtaining a desired level of puncture resistance in the overall anti-puncture device. For embodiments utilizing a puncture resistant layer 12 comprising a single layer of fabric formed of polyester fibers, preferred constructions will provide a bulk density, excluding any coating layers, of at least about 0.4 grams per cubic centimeters, and more preferably at least about 0.6 grams per cubic centimeters. More generally, for any given polymeric base fiber material, preferred constructions will provide a bulk density, excluding any coating layers, that is at least about 30% of the density of any polymeric material forming the fibers of the fabric layers, more preferably at least about 45%.

The bulk density values referred to directly above can be measured by calculating the volume of the fabric material and dividing the measured mass of the fabric material by this volume. Mass of the fabric material can be measured directly, as can the length and width dimensions of the fabric. Thus, in general, the thickness of the fibrous materials comprising the fabrics of the invention is the only factor in the bulk density calculation that requires definition. Various well-known ASTM methods for determining thickness of fabrics can be used for most typical materials. However, in the case of felts, or other bulky fabrics, the thickness should be measured while applying a load to the fabric tending to compress its thickness in order to simulate the density of the fabric in service. For a typical tire applications, a test load of about 35 lbs. per square foot is generally sufficient. Such measurement, under load, more accurately reflects the effective density of the fabric when utilized in operation.

For embodiments involving puncture layer fabrics formed from polyester fibers, typical bulk densities, excluding any applied coating layers, for the single fabric layer puncture resistant layer configurations described herein will preferably range from about 0.6 to about 0.9 grams per cubic centimeter (more generally, for any given polymeric base fiber material, preferred constructions will provide a bulk density, excluding any coating layers, that is at between about 45% and about 65% of the density of any polymeric material forming the fibers of the fabric layers). For embodiments where puncture resistant layer 12 is formed from multiple layers of lower cover fabric, for fabrics formed from polyester fibers, each fabric layer preferably has a bulk density of at least about 0.3 grams per cubic centimeters before coating and, in typical embodiments has a bulk density of between about 0.3 and about 0.6 grams per cubic centimeters before coating (more generally, for any given polymeric base fiber material, such preferred constructions will provide a bulk density, excluding any coating layers, that is at least about 20% of the density of any polymeric material forming the fibers of the fabric layers and typically between about 20% and about 45% of the density of the polymeric material).

Coating Systems for Improving Fabric Puncture Resistance

As discussed above, the puncture resistance of puncture resistant fabric layers provided according to the invention can be improved by applying polymeric, and preferably elastomeric. coatings to the fabrics used for the puncture-resistant layer(s). Such coatings are applied in liquid form to the fabric so that they penetrate into and preferably at least partially through the puncture resistant fabrics comprising the puncture resistant fabric layer 12. Subsequent to application, the coatings are caused/allowed to harden on/within the fabric. Given the inevitability of having void space within the fiber structure of fabrics, coating of the fabrics with such hardenable polymeric materials, especially saturation coating of the fabrics, can substantially increase the bulk density and puncture resistance of the fiber structure within the fabric.

As described above, tight weaving and provision of high fiber or bulk density in the weaving, knitting or felting fabric fabrication steps all play an important role in forming a base fabric substrate having desirable density and penetration resisting characteristics. Fabric shrinkage and consolidation by callendering, also as described above, can add to the overall substrate density and further improve the level of puncture resistance. However, even with these techniques, a substantial amount of void space within the fabric substrates can typically still be present. The coating of the fiber bundles with a hardenable resin, and especially saturation coating of the fiber bundles, can serve to substantially fill these voids. In preferred embodiments, the polymeric coating materials utilized to coat the fabrics in order to improve puncture resistance comprise coatings formed of hardenable elastomeric materials having a bulk modulus, upon hardening, not exceeding about 10,000 psi, and more preferably not exceeding about 5,000 psi, such coatings referred to herein as “soft” coatings. In addition, penetration resistance created by such coatings can be further improved by incorporation various granular materials in the coating solutions, for example ceramics, diamond or other hard materials. Such hardenable polymeric coatings, additive materials, and methods for performing fabric coatings utilizing the materials is discussed extensively in commonly owned U.S. patent application Ser. No. 09/691,491 and International Patent Application Ser. No. PCT/US00/28796, which has an International Publication No. WO01/29299, each of the above incorporated herein by reference.

For puncture-resistant layers formed of fabrics having a lower fiber density and more open structure, “hard”, higher modulus coatings (i.e. having bulk moduli upon hardening substantially exceeding 10,000 psi) may need to be utilized to provide acceptable penetration resistance. Such coating materials, for example epoxy materials, and associated coating methods are described in detail in commonly owned U.S. Pat. No. 5,565,264 previously incorporated by reference.

Puncture-resistant layers formed of fabrics and including one of the above-described coatings can resist puncture by at least two mechanisms: 1) by the tensile strength of the fibers themselves positioned at the tip and shank of the penetrator where filaments or fibers must be broken in order to allow for passage of the penetrator; and 2) by friction between the penetrator and the material of the puncture-resistant coating. As described above, preferred coatings for use in the context of the invention have a relatively low bulk modulus (e.g., less than 10,000 psi) and, in some preferred embodiments, include therein fillers and abrasives able to control the hardness of the coating and increase the coefficient of friction with respect to a penetrator. For embodiments where coatings are utilized that contain abrasive fillers for increasing the coefficient of friction, puncture-resistant fabric layers including such coatings are preferably physically isolated from the tire cords and any inner tube within the tire, for example by covering layers as described in more detail below, since such puncture-resistant layers will tend to have a high level of abrasion tending to cause damage to the tire cords and/or inner tube.

Puncture-resistant layers provided according to the invention as described above, especially those including puncture-resistant coatings, tend to have a relatively high degree of abrasion resistance. Abrasion resistance, as used herein, is characterized by a fabric abrasion limit measured with the well-known Tabor test (e.g. using ASTM 3884 test method). Abrasion limits referred to herein are those measured by the Tabor test method performed utilizing a CS10-type wheel and 1000 gram mass. Failure in this test is defined as the point where the fabric integrity is compromised and would not hold up in a liner service inside a tire. Specifically, failure is defined herein as the point at which the tensile strength of the fabric has decreased by about 25%.

Typically, puncture-resistant layers configured as described previously are able to withstand between about 4000 and about 20,000 cycles until failure. Such high abrasion resistant material can have a tendency to cause wear and damage to material utilized for formulating tires and inner tubes, for example butyl rubber. Accordingly, and as described and illustrated previously in FIG. 3, preferred embodiments for providing an anti-puncture device 10, especially for configurations where the anti-puncture device comprises a tire lining strip, include one or more low abrasion covering layers (e.g., layers 14 and/or 16) to reduce the degree of wear and damage inflicted upon the tire and/or inner tube by puncture-resistant layer 12 during service. Preferred covering layers 14, 16 are formed from fabrics having an abrasion limit of less than 2000 cycles as measured with the Tabor test, more preferably less than 1500 cycles, and most preferably between about 500 and about 1500 cycles.

As previously discussed, such covering layers can be bonded to puncture-resistant layer 12 by a variety of conventional bonding agents, the agents forming bonding layers 18 and 20, or, alternatively, covering layers 14 and/or 16 may be layered with puncture-resistant layer 12 without bonding or can be laminated to the puncture-resistant layer via stitching or other intermediate mechanical connection. A variety of materials can be utilized for forming the low abrasion covering layers according to the invention. Natural fibers, such as cellulosic materials, blends of natural and synthetic fibers, and fabrics formed therefrom, typically meet the above-described abrasion criteria for forming the covering layers. In one embodiment, the covering layers are formed of a cotton fabric, and in another embodiment, the covering layers are formed of a poly/cotton blend fabric.

In addition, in order to prevent damage to the tire and/or air holding inner tube and/or anti-puncture device, especially for embodiments where the anti-puncture device is provided in the form of a liner strip inserted within the tire as shown in FIG. 1, it is generally desirable to maintain the overall thickness of the puncture-resistant layer(s) together with any bonding layers and/or covering layers as thin as possible while still maintaining acceptable puncture resistance of the overall system. The mass of the overall anti-puncture system will tend to also be reduced by reducing the overall thickness of the system. A thinner anti-puncture layer, especially when utilized as a liner positioned between the inner surface of the tire and an inner tube, will also tend to cause a lower degree of wear and damage to the inner tube and the tire.

As well as the overall thickness of the system, the step changes in thickness occurring at the interfaces of the various layers of the system (e.g., at interfaces 26, 28 in FIG. 3) are also preferably minimized so that thickness transitions from layer to layer are as gradual as possible. In general, three types of damage can result due to step changes in thickness of the layers of the anti-puncture device: 1) damage to the tire cord layer 7 (see FIG. 1); 2) damage to the covering layer(s) of the anti-puncture device (e.g., layers 14, 16); and 3) damage to any air-holding inner tube within the tire. For systems utilized in tires including inner tubes, when under pressure, the inner tube tends to push the anti-puncture device 10, when configured as a liner as shown in FIG. 1, into the tire inner cord layer 7. Damage can result to either the liner 10 or the tire cord layer 7 from large step changes in the liner thickness between layers thereof. The above-mentioned pressure will tend to force the shoulder of a step into the cord layer and can thereby cause abrasive wear during cycling of the tire assembly. In addition to potential damage to the tire cord layer, a large step in the thickness of the liner 10 can also cause damage to a covering layer of the liner. Similarly, shoulders at step transitions of the liner 10 can also become points of local abrasion causing wear and failure of an inner tube disposed within the tire in which the liner is installed. Damage to inner tubes can be especially problematic since the most common inner tube material is butyl rubber elastomer. This elastomer has a very low abrasion resistance. It is been found, within the context of the present invention, that unacceptable levels of damage and wear of the inner tube can result from step changes in thickness of 0.01 inch, or even less, if the material comprising the layer forming the shoulder in abrasive contact with the inner tube has a higher level of abrasion resistance than butyl rubber.

FIG. 3 also illustrates a preferred arrangement for configuring covering layers 14 and 16 and puncture-resistant layer 12 in order to prevent or minimize any damage caused to the tire/inner tube due to step changes in thickness at the interfaces between the layers. Specifically, the overall width and length of at least one, and preferably both, of covering layers 14 and 16 exceeds that of puncture-resistant layer 12 such that the covering layers can overlap the sides 30 of the higher abrasion puncture-resistant layer 12 (e.g., in regions 32 and 34) to prevent contact between the tire and/or inner tube and the relatively high abrasion resistant puncture-resistant layer 12.

In general, puncture-resistant layer 12 and covering layers 14 and 16 are not required to be bonded together such that the layers have a high level of interlayer bond peel strength. In service, air pressure within the tire and/or inner tube tends to hold the layers of anti-puncture system 10 as illustrated in FIGS. 1 and 3 in place relative to each other. In hard cornering or breaking by a vehicle on which the tires are installed, some interlayer shear may occur. For typical levels of such shear, the interlayer bond strength need not exceed about 1.5 lbs./in. of bond line in peel. Other characteristics of preferred bonding layers for bonding together covering layers 14 and 16 and pressure resistant layer 12 (and/or any multiple fabric layers comprising a multi-layer puncture-resistant layer) include good temperature resistance. In hot weather, an asphalt roadway can reach temperatures in excess of about 150° F.

Accordingly, utilization of adhesives for bonding layers 18 and 20 that do not soften significantly at temperatures up to and including 150° F. are preferred, and even more preferred are those that do not soften significantly at temperatures up to about 300° F.

The function and advantage of these and other embodiments of the present invention will be more fully understood from the examples below. The following examples are intended to illustrate the benefits of the present invention, but do not exemplify the full scope of the invention.

### EXAMPLES 1-7

The table below summarizes the characteristics of eight woven fabric systems for forming a puncture-resistant layer(s) having a puncture resistance equal to or exceeding the minimum acceptable level previously described (i.e. 2 lb. force). The Examples in the table below are presented to illustrate the range of fiber density, single and multi-layer construction, and types of coatings that can be utilized in combination to satisfy the above-described puncture resistance criteria. While the materials in the table below comprise woven fabrics, it should be understood that felts or knitted fabrics providing a similar fiber content, as discussed previously, could also be utilized in place of the woven fabrics to provide essentially equivalent fiber densities and puncture resistance in both the single and multi-layer designs illustrated.

| | Example 1 | Example 2 | Example 3 | Example 4 | Example 5 | Example 6 | Example 7 |
|---|---|---|---|---|---|---|---|
| Fabric Type | Very High | High cover | Very High | Very High | Very High | Taped out fiber | High cover |
| | cover | | cover | cover | cover | (Measurements/ | |
| | | | | | | Calculations | |
| | | | | | | based on | |
| | | | | | | individual | |
| | | | | | | filaments) | |
| Coating type | soft | Hard | Soft | soft | soft | Hard | Hard |
| Fabric Layers | single | single | Single | single | single | Multiple | multiple |
| Warp denier | 220 | 150 | 100 | 500 | 1000 | 2.73 | 70 |
| Fill denier | 220 | 250 | 100 | 500 | 1000 | 2.73 | 70 |
| Ends per inch | 129 | 88 | 190 | 85 | 60 | 1320 | 120 |
| Picks per inch | 70 | 60 | 105 | 47 | 33 | 1320 | 90 |
| Specific | 1.38 | 1.38 | 1.38 | 1.38 | 1.38 | 1.38 | 1.38 |
| Gravity (SG) | | | | | | | |
| warp | | | | | | | |
| SG fill | 1.38 | 1.38 | 1.38 | 1.38 | 1.38 | 1.38 | 1.38 |
| Diameter warp | 0.0059 | 0.0049 | 0.0040 | 0.0089 | 0.0126 | 0.0007 | 0.0033 |
| inch | | | | | | | |
| Diameter fill | 0.0059 | 0.0063 | 0.0040 | 0.0089 | 0.0126 | 0.0007 | 0.0033 |
| inch | | | | | | | |
| Number of crossing points | 9030 | 5280 | 19950 | 999 | 1980 | 14400 | 10800 |
| Cover/Density: | | | | | | | |
| % of Full in Warp | 76.24% | 42.95% | 75.71% | 75.74% | 75.60% | 86.86% | 40.01% |
| % full in Fill | 82.74% | 67.08% | 83.68% | 83.75% | 83.16% | 86.86% | 60.01% |
| Sum of warp and fill % | 158.99% | 110.03% | 159.39% | 159.49% | 158.77% | 173.73% | 100.02% |
| % of Full in Warp w/shrinkage | 82.34% | 46.38% | 81.77% | 84.82% | 84.68% | 97.29% | 43.21% |
| % full in Fill w/ shrinkage | 86.88% | 70.44% | 87.86% | 87.94% | 87.32% | 88.60% | 63.01% |
| Weight | 6.56 | 4.06 | 4.30 | 9.61 | 13.55 | 1.03 | 2.11 |
| oz/yd.sq. | | | | | | | |
| Post Shrinkage weight oz/yd sq | 7.44 | 4.61 | 4.87 | 11.30 | 15.93 | 1.18 | 2.40 |
| Coating weight add oz/yd sq. | 2.00 | 2.00 | 1.50 | 3.00 | 3.50 | 0.50 | 1.00 |
| Finished weight oz/yd sq. | 9.44 | 6.61 | 6.37 | 14.30 | 19.43 | 1.68 | 3.40 |

Those skilled in the art would readily appreciate that all parameters and configurations described herein are meant to be exemplary and that actual parameters and configurations will depend upon the specific application for which the systems and methods of the present invention are used. Those skilled in the art will recognize, or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described. The present invention is directed to each individual feature, system, or method described herein. In addition, any combination of two or more such features, systems or methods, provided that such features, systems, or methods are not mutually inconsistent, is included within the scope of the present invention.

What is claimed:

1. A tire anti-puncture device comprising:
a puncture-resistant layer comprising at least two layers of woven fabric material, each layer having a taped fiber density of at least about 80% of full in at least one of the warp and fill and comprising fibers having a tenacity of less than about 15 g/denier, wherein the puncture-resistant layer is shaped and configured to form a belt within and around the periphery a tire.

2. The tire anti-puncture device of claim 1, wherein each of said layers of fabric has a bulk density, excluding any coatings applied to the fabric layers, that is at least about 20% of the density of any polymeric material forming the fibers of the fabric material.

3. The tire anti-puncture device of claim 1, further comprising at least one covering layer having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%.

4. The tire anti-puncture device of claim 1, wherein the puncture-resistant layer has a puncture resistance of greater than about 2.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch.

5. The tire anti-puncture device of claim 1, wherein the at least two layers of fabric material are physically stacked upon each other without being bonded to each other.

6. The tire anti-puncture device of claim 1, wherein the at least two layers of fabric material are bonded to each other.

7. The tire anti-puncture device of claim 6, wherein the at least two layers are bonded together by an intermediate bonding layer.

8. The tire anti-puncture device of claim 7, wherein the intermediate bonding layer comprises materials that do not soften significantly at temperatures up to and including about 150° F.

9. The tire anti-puncture device of claim 8, wherein the intermediate bonding layer comprises materials that do not soften significantly at temperatures up to about 300° F.

10. The tire anti-puncture device of claim 6, wherein the at least two layers are bonded together by a mechanical process.

11. The tire anti-puncture device of claim 10, wherein the at least two layers are bonded together by needling.

12. The tire anti-puncture device of claim 1, wherein the device comprises a separable strip shaped and configured to be removably insertable within a tire.

13. The tire anti-puncture device of claim 1, wherein the device comprises a strip bonded to an inner surface of a tire.

14. The tire anti-puncture device of claim 1, wherein the device is located within the cross-section of a tire body.

15. The tire anti-puncture device of claim 14, wherein the device is located within the cross-section of a tire body on a tread-facing side of a cord layer of the tire body.

16. The tire anti-puncture device of claim 14, wherein the device is located within the cross-section of a tire body on a tube- or rim-facing side of a cord layer of the tire body.

17. The tire anti-puncture device of claim 1, wherein each layer of fabric material comprises fibers having a tenacity of less than about 8 g/denier.

18. The tire anti-puncture device of claim 18, wherein each layer of fabric material comprises fibers having a tenacity of between about 3 g/denier and about 8 g/denier.

19. The tire anti-puncture device of claim 1, wherein each layer of fabric material comprises polyamide fibers.

20. The tire anti-puncture device of claim 1, wherein each layer of fabric material comprises polyester fibers.

21. The tire anti-puncture device of claim 1, wherein each layer has a taped fiber density of at least about 85% of full in at least one of the warp and fill.

22. The tire anti-puncture device of claim 21, wherein each layer has a taped fiber density of at least about 95% of full in at least one of the warp and fill.

23. The tire anti-puncture device of claim 1, wherein yarns comprising the woven fabric material have a weight per unit length of between 20 denier and about 100 denier.

24. The tire anti-puncture device of claim 1, wherein the layers of fabric material have been densified by calendering or shrinking the layers.

25. The tire anti-puncture device of claim 1, wherein yarns comprising the woven fabric material are untwisted.

26. A tire comprising the tire anti puncture device of claim 1.

27. A tire anti-puncture device comprising:
a puncture-resistant layer comprising a woven fabric having a round packed cover factor of at least about 40% of full in the warp and at least about 65% of full in the fill, the fabric comprising fibers having a tenacity of less than about 15 g/denier, wherein the puncture-resistant layer is shaped and configured to form a belt within and around the periphery a tire.

28. The tire anti-puncture device of claim 27, wherein the woven fabric has a bulk density, excluding any coatings applied to the fabric, that is at least about 20% of the density of any polymeric material forming the fibers of the fabric material.

29. The tire anti-puncture device of claim 27, further comprising at least one covering layer having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%.

30. The tire anti-puncture device of claim 27, wherein the puncture-resistant layer has a puncture resistance of greater than about 2.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch.

31. The tire anti-puncture device of claim 27, further comprising a coating applied to the woven fabric, the coating comprising a polymeric material that penetrates into and occupies at least a portion of the void space between fibers forming the fabric.

32. The tire anti-puncture device of claim 27, further comprising a coating applied as a liquid to the woven fabric, the applied coating, upon hardening, comprising a polymeric material having a bulk modulus not exceeding about 10,000 psi.

33. The tire anti-puncture device of claim 27, further comprising a coating applied as a liquid to the woven fabric, the applied coating, upon hardening, comprising a polymeric material having dispersed therein an abrasive particulate material.

34. The tire anti-puncture device of claim 27, wherein the puncture-resistant layer comprises a single layer of fabric material.

35. The tire anti-puncture device of claim 34, wherein the layer of fabric material has a a round packed cover factor of at least about 50% of full in the warp.

36. The tire anti-puncture device of claim 35, wherein the layer of fabric material has a a round packed cover factor of at least about 65% of full in the warp.

37. The tire anti-puncture device of claim 36, wherein the layer of fabric material has a a round packed cover factor of at least about 75% of full in the warp.

38. The tire anti-puncture device of claim 34, wherein the layer of fabric material has a a round packed cover factor of at least about 75% of full in the fill.

39. The tire anti-puncture device of claim 38, wherein the layer of fabric material has a a round packed cover factor of at least about 85% of full in the fill.

40. The tire anti-puncture device of claim 27, wherein the puncture-resistant layer comprises at least two layers of fabric material.

41. The tire anti-puncture device of claim 40, wherein the at least two layers of fabric material are bonded together.

42. The tire anti-puncture device of claim 27, wherein the device comprises a separable strip shaped and configured to be removably insertable within a tire.

43. The tire anti-puncture device of claim 27, wherein the device comprises a strip bonded to an inner surface of a tire.

44. The tire anti-puncture device of claim 27, wherein the device is located within the cross-section of a tire body.

45. The tire anti-puncture device of claim 44, wherein the device is located within the cross-section of a tire body on a tread-facing side of a cord layer of the tire body.

46. The tire anti-puncture device of claim 44, wherein the device is located within the cross-section of a tire body on a tube- or rim-facing side of a cord layer of the tire body.

47. The tire anti-puncture device of claim 27, wherein the woven fabric comprises fibers having a tenacity of less than about 8 g/denier.

48. The tire anti-puncture device of claim 47, wherein the woven fabric comprises fibers having a tenacity of between about 3 g/denier and about 8 g/denier.

49. The tire anti-puncture device of claim 27, wherein the woven fabric comprises polyamide fibers.

50. The tire anti-puncture device of claim 27, wherein the woven fabric comprises polyester fibers.

51. The tire anti-puncture device of claim 34, wherein yarns comprising the layer of woven fabric material have a weight per unit length of between 100 denier and about 500 denier.

52. A tire comprising the tire anti puncture device of claim 27.

53. A tire anti-puncture device comprising:
a puncture-resistant layer comprising at least two layers of fabric, each of said layers of fabric comprising fibers having a tenacity of less than about 15 g/denier and each of said layers of fabric having a bulk density, excluding any coatings applied to said fabric layer, that is at least about 20% of the density of any polymeric material forming the fibers of the fabric layers, wherein the puncture-resistant layer is shaped and configured to form a belt within and around the periphery a tire.

54. The tire anti puncture device if claim 53, wherein each of said layers of fabric has a bulk density, excluding any coatings applied to said fabric layer, that is between about 20% and about 45% of the density of any polymeric material forming the fibers of the fabric layers.

55. The tire anti puncture device if claim 53, wherein each of said layers of fabric has a bulk density, excluding any coatings applied to said fabric layer, of between about 0.3 g/cm³ and about 0.6 g/cm³.

56. The tire anti puncture device if claim 53, wherein the puncture-resistant layer has a puncture resistance of greater than about 2.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch.

57. The tire anti puncture device if claim 53, further comprising at least one covering layer having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%.

58. The tire anti-puncture device of claim 53, further comprising a coating applied to at least one of the at least two layers of fabric, the coating comprising a polymeric material that penetrates into and occupies at least a portion of the void space between fibers forming the fabric.

59. The tire anti-puncture device of claim 53, further comprising a coating applied as a liquid to at least one of the at least two layers of fabric, the applied coating, upon hardening, comprising a polymeric material having a bulk modulus not exceeding about 10,000 psi.

60. The tire anti-puncture device of claim 53, further comprising a coating applied as a liquid to at least one of the at least two layers of fabric, the applied coating, upon hardening, comprising a polymeric material having dispersed therein an abrasive particulate material.

61. The tire anti-puncture device of claim 53, wherein at least one of the at least two layers of fabric comprises a non-woven fabric.

62. The tire anti-puncture device of claim 61, wherein each of the at least two layers of fabric comprises a non-woven fabric.

63. The tire anti-puncture device of claim 62, wherein each of the at least two layers of fabric comprises a knitted fabric.

64. The tire anti-puncture device of claim 62, wherein each of the at least two layers of fabric comprises a felted fabric.

65. The tire anti-puncture device of claim 62, wherein each of the at least two layers of fabric has a weight per unit area of between about 0.5 oz./sq. yd. and about 3 oz./sq. yd.

66. The tire anti-puncture device of claim 53, wherein at least one of the at least two layers of fabric comprises a woven fabric.

67. The tire anti-puncture device of claim 66, wherein each of the at least two layers of fabric comprises a woven fabric.

68. The tire anti-puncture device of claim 67, wherein each of the at least two layers of fabric comprises a woven fabric having a round packed cover factor of at less than about 40% of full in the warp and at less than about 65% of full in the fill.

69. The tire anti-puncture device of claim 67, wherein each of the at least two layers of fabric comprises a woven fabric having a taped fiber density of at less than about 80% of full in both the warp and fill.

70. The tire anti-puncture device of claim 67, wherein yarns comprising the woven fabric layers have a weight per unit length of between 20 denier and about 100 denier.

71. The tire anti-puncture device of claim 65, wherein each of the at least two layers of fabric has a weight per unit area of between about 0.5 oz./sq. yd. and about 3 oz./sq. yd.

72. The tire anti-puncture device of claim 53, wherein each layer of fabric comprises fibers having a tenacity of less than about 8 g/denier.

73. The tire anti-puncture device of claim 72, wherein each layer of fabric comprises fibers having a tenacity of between about 3 g/denier and about 8 g/denier.

74. The tire anti-puncture device of claim 53, wherein each layer of fabric comprises polyamide fibers.

75. The tire anti-puncture device of claim 53, wherein each layer of fabric comprises polyester fibers.

76. A tire comprising the tire anti puncture device of claim 53.

77. A tire anti-puncture device comprising:
a puncture-resistant layer comprising a single fabric layer, the fabric layer comprising fibers having a tenacity of less than about 15 g/denier and the fabric layer having a bulk density, excluding any coatings applied to the fabric layer that is at least about 30% of the density of any polymeric material forming the fibers of the fabric layer, wherein the puncture-resistant layer is shaped and configured to form a belt within and around the periphery a tire.

78. The tire anti-puncture device of claim 77, wherein said layer of fabric has a bulk density, excluding any coatings applied to said fabric layer, that is at least about 45% of the density of any polymeric material forming the fibers of the fabric layer.

79. The tire anti-puncture device of claim 78, wherein said layer of fabric has a bulk density, excluding any coatings applied to said fabric layer, that between about 45% and about 65% of the density of any polymeric material forming the fibers of the fabric layer.

80. The tire anti puncture device if claim 77, wherein said layer of fabric has a bulk density, excluding any coatings applied to said fabric layer, of between about 0.6 g/cm³ and about 0.9 g/cm³.

81. The tire anti puncture device if claim 77, wherein the puncture-resistant layer has a puncture resistance of greater than about 2.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch.

82. The tire anti puncture device if claim 77, further comprising at least one covering layer having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%.

83. The tire anti puncture device if claim 77, further comprising a coating applied to said layer of fabric, the coating comprising a polymeric material that penetrates into and occupies at least a portion of the void space between fibers forming the fabric.

84. The tire anti puncture device if claim 77, further comprising a coating applied as a liquid to at least said layer of fabric, the applied coating, upon hardening, comprising a polymeric material having a bulk modulus not exceeding about 10,000 psi.

85. The tire anti-puncture device of claim 77, further comprising a coating applied as a liquid to said layer of fabric, the applied coating, upon hardening, comprising a polymeric material having dispersed therein an abrasive particulate material.

86. The tire anti-puncture device of claim 77, wherein said fabric layer comprises a woven fabric.

87. The tire anti-puncture device of claim 86, wherein yarns comprising the woven fabric layer have a weight per unit length of between 100 denier and about 500 denier.

88. The tire anti-puncture device of claim 86, wherein said layer of fabric has a weight per unit area of between about 3 oz./sq. yd. and about 15 oz./sq. yd.

89. The tire anti-puncture device of claim 77, wherein said fabric layer comprises a non-woven fabric.

90. The tire anti-puncture device of claim 89, wherein said layer of fabric has a weight per unit area of between about 0.5 oz./sq. yd. and about 3 oz./sq. yd.

91. The tire anti-puncture device of claim 89, wherein said layer of fabric comprises a knitted fabric.

92. The tire anti-puncture device of claim 89, wherein said layer of fabric comprises a felted fabric.

93. The tire anti-puncture device of claim 77, wherein said layer of fabric comprises fibers having a tenacity of less than about 8 g/denier.

94. The tire anti-puncture device of claim 93, wherein said layer of fabric comprises fibers having a tenacity of between about 3 g/denier and about 8 g/denier.

95. The tire anti-puncture device of claim 77, wherein said layer of fabric comprises polyamide fibers.

96. The tire anti-puncture device of claim 95, wherein said layer of fabric comprises polyester fibers.

97. A tire comprising the tire anti puncture device of claim 77.

98. A tire anti-puncture device comprising:
a puncture-resistant layer comprising at least one fabric layer comprising fibers having a tenacity of less than about 15 g/denier; and
at least one covering layer having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%, wherein the puncture-resistant layer is shaped and configured to form a belt within and around the periphery a tire.

99. The tire anti-puncture product of claim 98, wherein the device comprises a separable strip shaped and configured to be removably insertable within a tire.

100. The tire anti-puncture device of claim 98, wherein the device comprises a strip bonded to an inner surface of a tire.

101. The tire anti-puncture device of claim 98, wherein the device comprises a single covering layer.

102. The tire anti-puncture device of claim 101, wherein the device is configured to be inserted within the interior of a tire body such that the covering layer faces an inner-tube within the interior of the tire body, when inserted within a tire.

103. The tire anti-puncture device of claim 101, wherein the width of the covering layer exceeds the width of the puncture resistant layer.

104. The tire anti-puncture device of claim 98, wherein the device comprises a two covering layers.

105. The tire anti-puncture device of claim 104, wherein the puncture resistant layer is positioned between the two covering layers.

106. The tire anti-puncture device of claim 105, wherein the width each of the covering layers exceeds the width of the puncture resistant layer.

107. The tire anti-puncture product of claim 98, wherein the puncture-resistant layer and the at least one covering layer are physically stacked upon each other without being bonded to each other.

108. The tire anti-puncture device of claim 98, the puncture-resistant layer and the at least one covering layer are bonded to each other.

109. The tire anti-puncture device of claim 108, wherein the puncture-resistant layer and the at least one covering layer are bonded to each other by at least one intermediate bonding layer.

110. The tire anti-puncture device of claim 109, wherein the intermediate bonding layer comprises materials that do not soften significantly at temperatures up to and including about 150° F.

111. The tire anti-puncture device of claim 110, wherein the intermediate bonding layer comprises materials that do not soften significantly at temperatures up to about 300° F.

112. The tire anti-puncture device of claim 108, wherein the puncture-resistant layer and the at least one covering layer are bonded to each other by a mechanical process.

113. The tire anti-puncture device of claim 112, wherein the puncture-resistant layer and the at least one covering layer are bonded to each other by needling.

114. A tire comprising the tire anti puncture device of claim 98.

115. A tire anti-puncture device comprising:
a puncture-resistant layer comprising a fabric comprising fibers having a tenacity of less than about 15 g/denier, the puncture-resistant layer further having a puncture resistance of greater than about 2.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch, wherein the puncture-resistant layer is shaped and configured to form a belt within and around the periphery a tire.

116. The tire anti-puncture device of claim 115, wherein the puncture-resistant layer has a puncture resistance of greater than about 3.0 lbs. force, wherein the puncture resistance is defined as the level force required to force a 0.05 in. diameter polished steel commercial hand sewing needle through the puncture-resistant layer, when clamped and supported in a 1 in. diameter ring, such that the point of the needle projects from the side of the fabric opposite that to which the force is applied by a distance of about 0.045 inch.

117. A tire comprising the tire anti puncture device of claim 115.

118. A tire anti-puncture device having a puncture-resistant layer comprising:
at least one fabric layer comprising fibers having a tenacity of less than about 15 g/denier; and
a coating applied to the fabric layer, the coating comprising a polymeric material that penetrates into and occupies at least a portion of the void space between fibers forming the fabric, wherein the puncture-resistant layer is shaped and configured to form a belt within and around the periphery a tire.

119. The tire anti-puncture device of claim 118, wherein the puncture-resistant layer comprises a single layer of fabric.

120. The tire anti-puncture device of claim 118, wherein the puncture-resistant layer comprises at least two fabric layers.

121. The tire anti-puncture device of claim 118, wherein the coating is applied as a liquid to the fabric layer, the applied coating, upon hardening, comprising a polymeric material having a bulk modulus not exceeding about 10,000 psi.

122. The tire anti-puncture device of claim 118, wherein the coating is applied as a liquid to the fabric layer, the applied coating, upon hardening, comprising a polymeric material having a bulk modulus exceeding about 10,000 psi.

123. The tire anti-puncture device of claim 118, wherein the coating is applied as a liquid to the fabric layer, the applied coating, upon hardening, comprising a polymeric material having dispersed therein an abrasive particulate material.

124. A tire comprising the tire anti puncture device of claim 118.

125. A tire anti-puncture device having a puncture-resistant layer comprising:
at least one fabric layer comprising fibers having a tenacity of less than about 15 g/denier; and
a coating applied as a liquid to the fabric layer, the applied coating, upon hardening, comprising a polymeric material having a bulk modulus not exceeding about 10,000 psi, wherein the puncture-resistant layer is shaped and configured to form a belt within and around the periphery a tire.

126. The tire anti-puncture device of claim 125, wherein the applied coating, upon hardening, comprises a polymeric material having dispersed therein an abrasive particulate material.

127. The tire anti-puncture device of claim 125, wherein the applied coating, upon hardening, comprises a polymeric material having a bulk modulus not exceeding about 2,000 psi.

128. The tire anti-puncture device of claim 127, wherein the applied coating, upon hardening, comprises a polymeric material having a bulk modulus not exceeding about 1,500 psi.

129. The tire anti-puncture device of claim 128, wherein the applied coating, upon hardening, comprises a polymeric material having a bulk modulus of between about 500 psi and about 1,500 psi.

130. A tire comprising the tire anti puncture device of claim 125.

131. A tire anti-puncture device having a puncture-resistant layer comprising:
at least one fabric layer comprising fibers having a tenacity of less than about 15 g/denier; and
a coating applied as a liquid to the fabric layer, the applied coating, upon hardening, comprising a polymeric material having dispersed therein an abrasive particulate material, wherein the puncture-resistant layer is shaped and configured to form a belt within and around the periphery a tire.

132. The tire anti-puncture device of claim 131, further comprising two covering layers each having an abrasion limit of less than about 2000 cycles as measured by a Tabor test utilizing a CS10 wheel with 1000 gram load, wherein the test is run to tensile failure, defined as the point where the tensile strength of the covering layer is reduced by about 25%, wherein the puncture-resistant layer is positioned between the two covering layers and the width of each of the two covering layers exceeds the width of the puncture-resistant

133. A tire comprising the tire anti puncture device of claim 131.
